(19) United States
(12) Patent Application Publication
(10) Pub. No.: US 2016/0259843 A1
(43) Pub. Date: Sep. 8, 2016

(54) RECORDING MEDIUM HAVING STORED THEREIN DATA MANAGEMENT PROGRAM, DATA MANAGEMENT DEVICE, AND DATA MANAGEMENT METHOD

(71) Applicant: FUJITSU LIMITED, Kawasaki-shi (JP)

(72) Inventors: Miho Murata, Kawasaki (JP); Toshiaki SAEKI, Kawasaki (JP); Nobutaka Imamura, Yokohama (JP)

(73) Assignee: FUJITSU LIMITED, Kawasaki-shi (JP)

(21) Appl. No.: 15/052,060

(22) Filed: Feb. 24, 2016

(30) Foreign Application Priority Data
Mar. 2, 2015 (JP) 2015-040783

(51) Int. Cl. G06F 17/30

(52) U.S. Cl. CPC G06F 17/30598; G06F 17/3053

(57) ABSTRACT

A computer monitors a relevance ratio between pieces of data based on a frequency of access to a pair for each of the pairs of the pieces of data consecutively accessed in response to a request for access to a storage device storing a plural pieces of data, determines whether the pair is a pair having a relevance ratio representing a specified tendency, on the basis of tendencies of the monitored relevance ratios of the pairs, groups the plural pieces of data according to a result of the determining and the relevance ratio, and specifies data to be arranged in each group.

### CROSS-REFERENCE TO RELATED APPLICATION

This application is based upon and claims the benefit of priority of the prior Japanese Patent Application No. 2015-040783, filed on Mar. 2, 2015, the entire contents of which are incorporated herein by reference.

### FIELD

The embodiments discussed herein are related to a recording medium having stored therein a data management program, a data management device, and a data management method.

### BACKGROUND

A data storage system stores a large amount of data in a storage such as a disk. A low-speed storage such as a disk has a low throughput per unit time (a high cost), and therefore a cache technology is used.

The cache technology is a technology for reducing processing time by using a memory when a controller that is high in processing speed reads data at a higher speed from a low-speed storage. When the controller reads data from the low-speed storage, the read data is temporality stored in a memory, and this allows the data to be read from the memory capable of performing higher-speed reading/writing than the low-speed storage from the next time.

However, when a large amount of data that exceeds a capacity of a memory is processed, access to a disk frequently occurs, and consequently performance of data processing greatly deteriorates.

Accordingly, as one of cache technologies, a technology for collecting mutually relevant data in the same segment in accordance with an access history so as to perform data rearrangement (hereinafter referred to as a “data rearrangement technology”) has been proposed (for example, Patent Document 1).

Patent Document 1: International Publication Pamphlet No. WO 2013/114538.

Patent Document 2: Japanese Laid-open Patent Publication No. 7-200389

Patent Document 3: Japanese Laid-open Patent Publication No. 2014-142749

Patent Document 4: Japanese Patent No. 5413867

### SUMMARY

According to one aspect, a non-transitory computer-readable recording medium having stored therein a data management program causes a computer to execute the process described below. The computer monitors a relevance ratio between pieces of data based on a frequency of access to a pair for each of the pairs of the pieces of data consecutively accessed in response to a request for access to a storage device storing a plural pieces of data. The computer determines whether the pair is a pair having a relevance ratio representing a specified tendency, on the basis of tendencies of the monitored relevance ratios of the pairs. The computer groups the plural pieces of data according to a result of the determining and the relevance ratio, and specifies data to be arranged in each group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A to 1D are diagrams explaining a relevance ratio for each data pair and data arrangement in a data rearrangement technology.

FIG. 2A illustrates an example of data arrangement according to actual relevance between pieces of data in a case in which relevance greatly changes in the middle of an accumulation period of relevance information. FIG. 2B illustrates an example of data arrangement according to relevance between pieces of data in a data rearrangement technology in a case in which relevance greatly changes in the middle of an accumulation period of relevance information.

FIGS. 3A to 3C illustrate examples of data arrangement in a case in which data pairs having different tendencies of the intensity of relevance (a relevance ratio) are mixed.

FIG. 4 illustrates an example of a data management device according to the embodiments.

FIG. 5 illustrates an example of an information processing system according to the embodiments.

FIG. 6 is a diagram explaining a relationship among an accumulation period T, a sub-period Tm, and a sub-sub-period Ts according to the embodiments.

FIG. 7 illustrates an example of a server according to the embodiments.

FIG. 8 illustrates an example of a data/segment correspondence table according to the embodiments.

FIG. 9 illustrates an example of a relevance management table according to the embodiments.

FIGS. 10A and 10B illustrate an example of relevance statistics management information according to the embodiments.

FIGS. 11A to 11C illustrate examples of invalid relevance information according to the embodiments.

FIG. 12 illustrates a flow of a process of accumulating relevance information according to the embodiments.

FIGS. 13A and 13B are diagrams explaining a process (S5) of calculating final relevance information according to the embodiments.

FIG. 14 illustrates finally obtained relevance information for each data pair according to the embodiments.

FIG. 15 is a diagram explaining relevance information and the determination of data arrangement according to the embodiments.

FIG. 16 illustrates an example of a flow from the arrival of a request to the determination of arrangement according to the embodiments.

### DESCRIPTION OF EMBODIMENTS

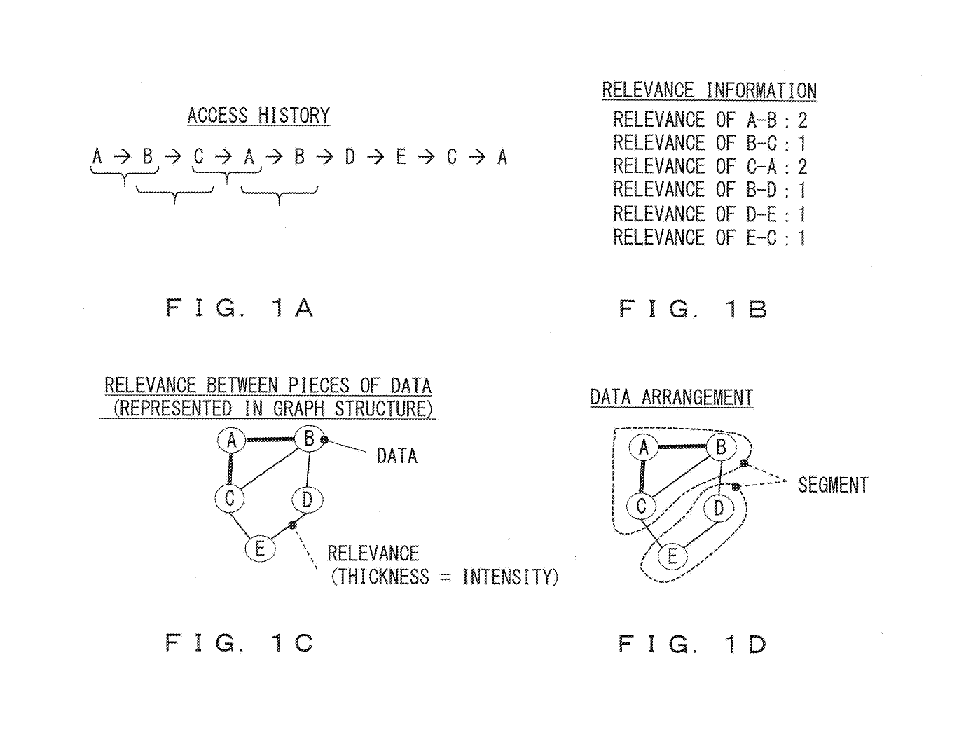

FIGS. 1A to 1D are diagrams explaining a relevance ratio for each data pair and data arrangement in a data rearrangement technology. In the data rearrangement technology, a frequency of concurrent access or consecutive access to each data pair (relevance information) is recorded for each of the data pairs in accordance with an access history of data (a history indicating which data is accessed in which order).

The data pair refers to two pieces of data that are consecutively accessed. Data accessed currently and data accessed just before form a pair, and a frequency at which the pair appears is recorded.

As illustrated in FIG. 1A, for example, assume that pieces of data A, B, C, D, and E are accessed in the order of A→B→C→A→B→D→E→C→A. In this case, data pairs and the access frequencies (appearance frequencies, namely, relevance information) of the data pairs are A→B (twice), B→C (once), C→A (twice), B→D (once), D→E (once), and E→C (once), as illustrated in FIG. 1B. It is considered that pieces of data forming a pair having a high access frequency are highly relevant to each other.

When relevance between pieces of data is represented by using a graph, the pieces of data A, B, C, D, and E have a structure illustrated in FIG. 1C.

In order to arrange these pieces of data into two segments, these pieces of data are divided into a group including the pieces of data A, B, and C, and a group including the pieces of data D and E, as illustrated in FIG. 1D. According to these groups, the pieces of data A, B, C, D, and E are rearranged into the respective segments. The pieces of data A, B, C, D, and E are divided in such a way that a relevance ratio between pieces of data that are respectively included in the two segments is low and that the number of pieces of data included in one segment is almost equal to the number of pieces of data included in the other segment. The segment refers to a set of relevant data, and is a minimum unit of reading/writing from/to a disk.

As described above, relevant pieces of data are collected in the same segment in accordance with the intensity of relevance of a data pair that is accumulated during a prescribed period so as to perform data rearrangement.

It is difficult to continue to accumulate all access histories and all pieces of relevance information as described above, and therefore histories during a prescribed period are recorded. As an example, a history of access to data on a cache is recorded while the data is stored on the cache. In this case, the intensity of relevance accumulated during a prescribed period is watched.

By using the above data rearrangement technology, when a tendency of an access history does not change, data arrangement having a high access efficiency is realized.

However, the tendency of the access history is not always stationary. When there is a data pair that greatly changes in relevance, there are the following concerns. When the tendency of the access history changes, data rearrangement is performed according to a change in the tendency. However, there is a data pair that changes in a relevance ratio more frequently than the tendencies of all of the access histories change, data rearrangement is performed more frequently than needed, and inefficient tasks are performed.

When relevance greatly changes in the middle of an accumulation period during which relevance information of data is accumulated, there are the following concerns. As an example, when data arrangement is determined without considering that pieces of data forming a data pair become irrelevant to each other, data arrangement based on relevance that no longer exists, namely, inefficient data arrangement is performed.

In one aspect of the invention, a technology is provided that enables data arrangement having a high reading efficiency according to a change in a tendency of a data access situation.

The problems above are described in further detail. A case in which there is a data pair that greatly changes in relevance is described first.

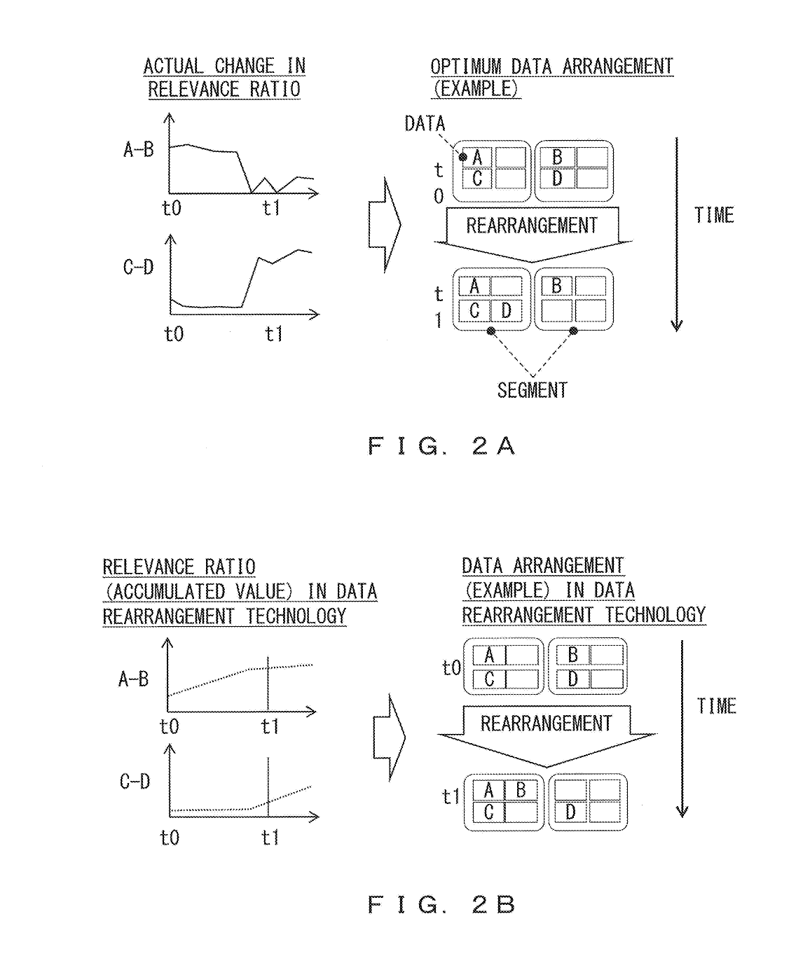

FIG. 2A illustrates an example of data arrangement according to actual relevance between pieces of data in a case in which relevance greatly changes in the middle of an accumulation period of relevance information. FIG. 2B illustrates an example of data arrangement according to relevance between pieces of data in the data rearrangement technology in a case in which relevance greatly changes in the middle of an accumulation period of relevance information. Note that data rearrangement is not performed during the accumulation period of the relevance information.

FIG. 2A illustrates an example of data arrangement according to actual relevance between pieces of data. Assume that, at time to, pieces of data A, B, C, and D happen to be divided into a segment including the pieces of data A and C, and a segment including the pieces of data B and D. Also assume that a timing of rearrangement is time t1.

In a case in which relevance between pieces of data changes by time t1 in such a way that a relevance ratio between the pieces of data A and B decreases, and a relevance ratio between the pieces of data C and D increases, rearrangement is performed, and the pieces of data A, C, and D are arranged in one segment, and the data B is arranged in the other segment.

FIG. 2B illustrates an example of data arrangement according to relevance in the data rearrangement technology. Assume that, at time t0, pieces of data A, B, C, and D happen to be divided into a segment including the pieces of data A and C, and a segment including the pieces of data B and D.

In the data rearrangement technology, relevance information prior to time t1 is not accumulated in order to prevent resources from being wasted, and therefore a change in relevance between pieces of data fails to be watched from time t0 to time t1. However, in the conventional data rearrangement technology, an accumulated value of the number of accesses to relevant data is stored.

Accordingly, unlike FIG. 2A, in FIG. 2B, relevance (an accumulated value) between the pieces of data A and B has increased by time t1, and therefore it is determined that the pieces of data A and B also have a high relevance at time t1. As a result, rearrangement is performed in such a way that the pieces of data A, B, and C is arranged in one segment, and the data D is arranged in the other segment.

Actually, the pieces of data C and D have a high relevance. Therefore, when the data C is accessed, it is highly probable that the data D is also accessed. However, the pieces of data C and D are not arranged in the same segment. Accordingly, it is highly probable that one of the pieces of data C and D does not exist in a memory, and another access to a disk is needed.

As described above, when data arrangement is determined without considering that relevance of a data pair no longer exists, data arrangement is performed according to relevance that no longer exists, and an effect of improvements in reading efficiency due to rearrangement is not exhibited in some cases.

A case in which relevance greatly changes in the middle of an accumulation period of relevance information is described next.

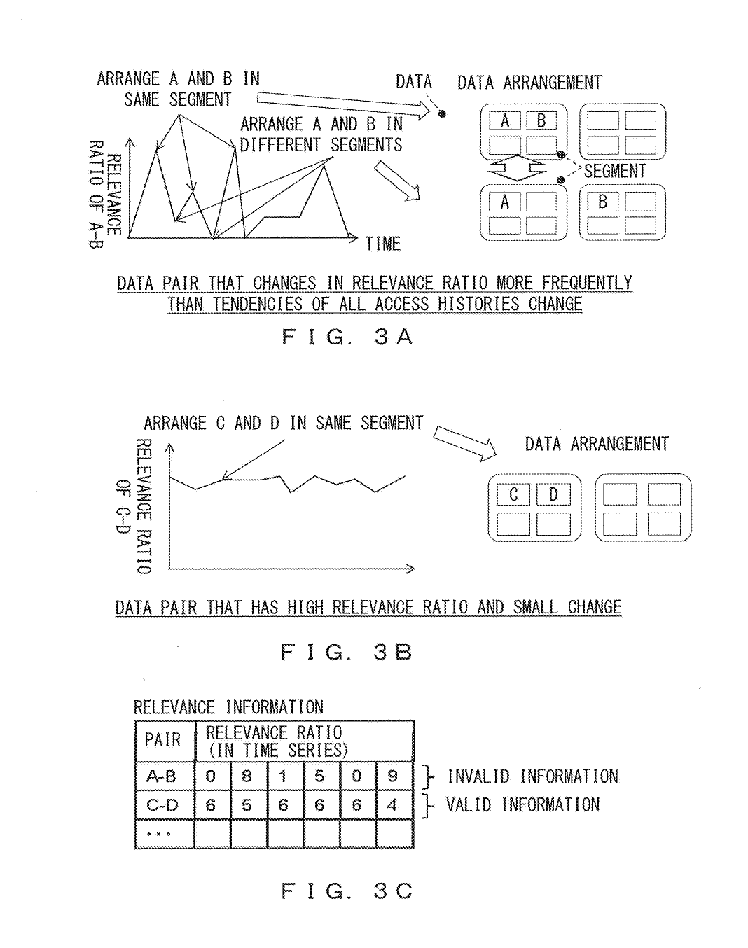

FIGS. 3A to 3C illustrate examples of data arrangement in a case in which data pairs having different tendencies of the intensity of relevance (a relevance ratio) are mixed. FIG. 3A illustrates an example of a data pair that changes in a relevance ratio more frequently than the tendencies of all of the access histories change. FIG. 3B illustrates an example of a data pair having a small change in a relevance ratio. FIG. 3C illustrates time-series relevance information (an access frequency) for each data pair.

In FIG. 3A, the relevance ratio of a data pair A-B greatly changes. When it is determined that pieces of data A and B have a high relevance ratio, the pieces of data A and B are arranged in the same segment in the conventional data rearrangement technology. When it is determined that the pieces of data A and B have a low relevance ratio, the pieces of data A and B are arranged in different segments (another data pair having a high relevance ratio is prioritized).

When rearrangement is performed according to a change in the relevance ratio, pieces of data are frequently replaced. Therefore, even when rearrangement is performed, an effect of improvements in a reading efficiency due to rearrangement is lost soon, and this results in a decrease in data throughput. Accordingly, as illustrated in FIG. 3C, it is considered that relevance information of a data pair that greatly changes in the relevance ratio is invalid information for rearrangement.

As illustrated in FIG. 3B, the relevance ratio of a data pair C-D is almost constant and high. Once pieces of data C and D are arranged in the same segment because the pieces of data C and D has a high relevance ratio, this state of arrangement is maintained, and a cache hit ratio is increased. In this case, rearrangement is performed only once, and an effect of improvements in reading efficiency due to rearrangement is easily exhibited. Accordingly, as illustrated in FIG. 3C, it is considered that relevance information of a data pair having a high relevance ratio and a small change in the relevance ratio is valid information for rearrangement.

Thus, when optimum data arrangement is determined, it is preferable that valid information and invalid information for rearrangement be distinguished from each other. The purpose of this is, for example, to exclude invalid information from a target to be rearranged.

Accordingly, the relevance ratio for each of the data pairs can be recorded as time-series information without recording the relevance ratio by using an accumulated value.

However, in the data rearrangement technology, a case in which data pairs have respective different tendencies of the relevance ratio is not considered, and relevance information of each of the data pairs is handled equivalently. Therefore, influence of invalid relevance information fails to be excluded.

Accordingly, in the embodiments, arrangement is not determined according to a relevance ratio every time the relevance ratio changes, but arrangement is determined while considering a tendency of the relevance ratio during a prescribed period (accumulation period). In addition, according to the tendency of the relevance ratio during a prescribed period, valid relevance information and invalid relevance information for the determination of arrangement are distinguished from each other.

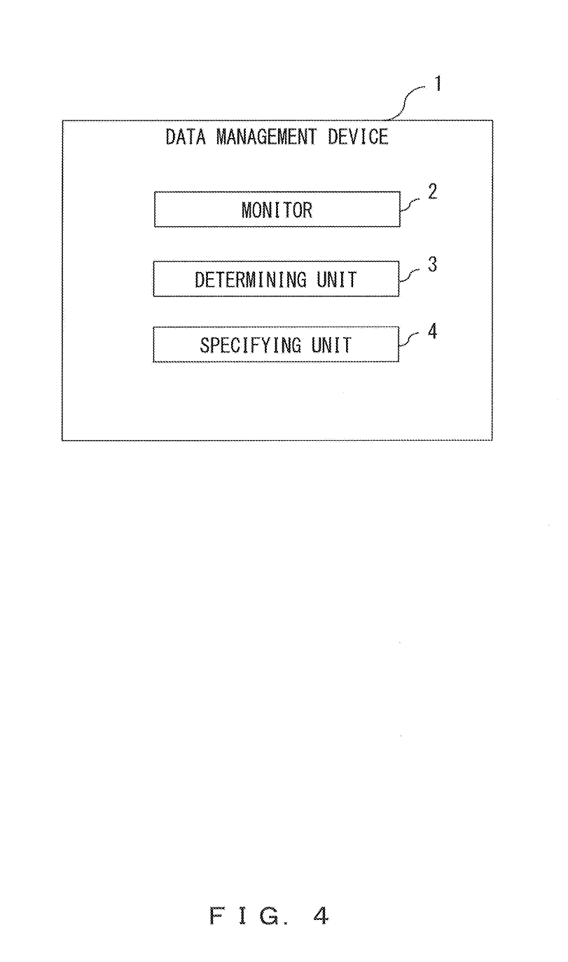

FIG. 4 illustrates an example of a data management device according to the embodiments. A data management device 1 includes a monitor 2, a determining unit 3, and a specifying unit 4.

The monitor 2 intermittently monitors a relevance ratio between pieces of data based on an access frequency to a data pair for each pair of pieces of data that are consecutively accessed in response to a request for access to a storage device storing a plural pieces of data. An example of the monitor 2 is the relevance extracting unit 22 described later.

The determining unit 3 determines whether a pair is a pair having a relevance ratio representing a specified tendency on the basis of tendencies of the intermittently monitored relevance ratios of the pairs. An example of the determining unit 3 is the statistics processing unit 23 described later.

The specifying unit 4 groups pieces of data in accordance with a determination result and the relevance ratio, and specifies pieces of data to be arranged in each group. An example of the specifying unit 4 is the arrangement determining unit 24 described later.

The configuration above enables data arrangement having a high reading efficiency according to a change in a tendency of a data access situation.

The monitor 2 divides a period during which a tendency of a relevance ratio is observed (an accumulation period) into a plurality of periods, and intermittently monitors a relevance ratio between pieces of data based on a frequency of access to a pair during each of the divided periods.

In the configuration above, the tendency of the relevance ratio between pieces of data forming a pair can be intermittently monitored during each of the divided periods.

The determining unit 3 calculates a mean or a standard deviation of the intermittently monitored relevance ratio during each of the divided periods for each of the pairs, and specifies a pair having a relevance ratio whereby the calculated mean or standard deviation satisfies a specified condition.

In the configuration above, invalid relevance information, such as a data pair that stationarily has a low relevance ratio, a data pair that greatly changes in the relevance ratio, or a data pair that changes in a tendency of the relevance ratio, can be specified.

The specifying unit 4 calculates a relevance ratio during an observation period for each pair by performing weighting on the mean of the relevance ratio during each of the divided periods of a pair as opposed to a pair having a relevance ratio representing a specified tendency in such a way that a weight is reduced in an order that goes back to the past from an immediately previous divided period.

In the configuration above, the immediately previous data pair has a greater weight of the relevance ratio, and a current relevance ratio is further reflected.

The specifying unit 4 groups pairs as opposed to a pair having a relevance ratio representing a specified tendency.

In the configuration above, when data arrangement for each segment is determined according to relevance between pieces of data, invalid relevance information can be excluded.

The embodiments are described below in detail.

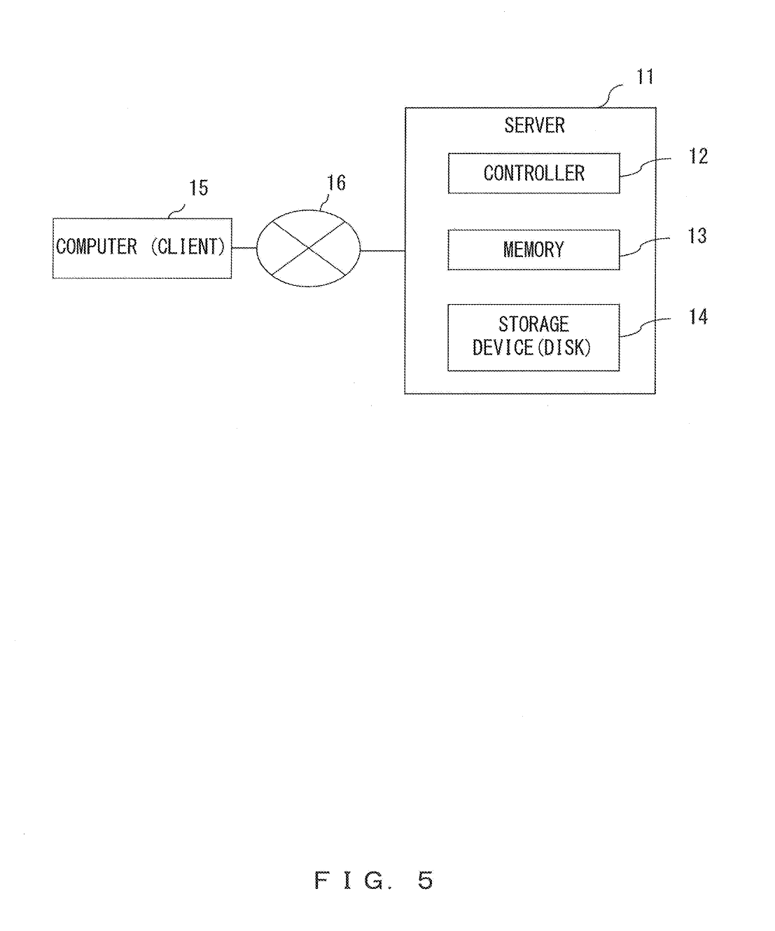

FIG. 5 illustrates an example of an information processing system according to the embodiments. In the information processing system, a server device (hereinafter referred to as a “server”) 11 is connected to a client 15, which is an example of an information processing device, via a communication network (hereinafter referred to simply as a “network”) 16. The client 15 issues an access request (hereinafter referred to as a “request”) such as reading/writing data from/to the server 11.

The server 11 includes a controller 12, a memory device (hereinafter referred to as a “memory”) 13, and a storage device (disk) 14. The controller 12 is a processor such as a central processing unit (CPU).

Examples of the storage device 14 include a disk drive such as a hard disk drive (HDD). Hereinafter, the storage device 14 is referred to as a disk 14.

The memory 13 is a storage that is accessible at a higher speed than the disk 14. Examples of the memory 13 include a RAM (Random Access Memory), a flash memory, and the like.

The server 11 includes a ROM storing a BIOS (Basic Input/Output System), a program memory, and the like, in addition to the configuration above. A program executed by the controller 12 may be obtained via the network 16, or may be obtained by a removable memory or a removable computer-readable recording medium such as a CD-ROM being mounted onto the server 11. The program executed by the controller 12 includes a program for executing a process described in the embodiments.

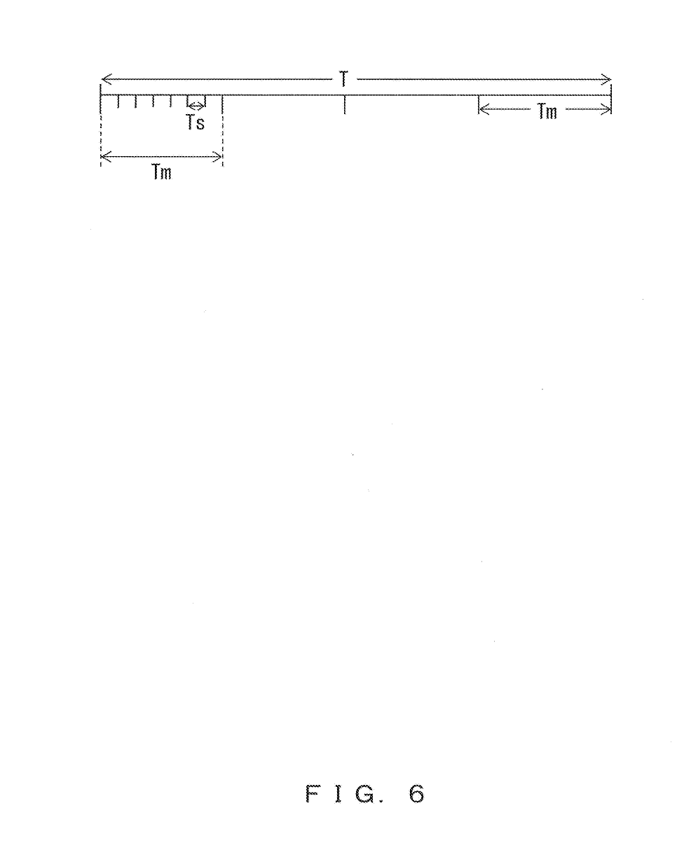

FIG. 6 is a diagram explaining a relationship among an accumulation period T, a sub-period Tm, and a sub-sub-period Ts according to the embodiments. The accumulation period T during which relevance information is accumulated is specified in advance. Depending on a data access frequency, the number of pieces of relevance information (a frequency of access to a data pair) per unit time changes, and therefore a time period during which the relevance information is accumulated is specified to a certain degree (for example, T=constant/average access frequency).

Next, the accumulation period T is divided into a plurality of sub-periods Tm, and the plurality of sub-periods Tm are further divided into a plurality of sub-sub-periods Ts. The number of consecutive accesses to each of the data pairs during each of the sub-sub-period Ts is measured. In order to determine whether relevance information of each of the data pairs is valid, a mean value and a standard deviation of the relevance ratio are calculated from a change in the number of accesses during each of the sub-sub-periods Ts within the sub-period Tm. As described later, a final relevance ratio for a data pair having valid relevance information is calculated on the basis of a mean relevance ratio during the accumulation period T.

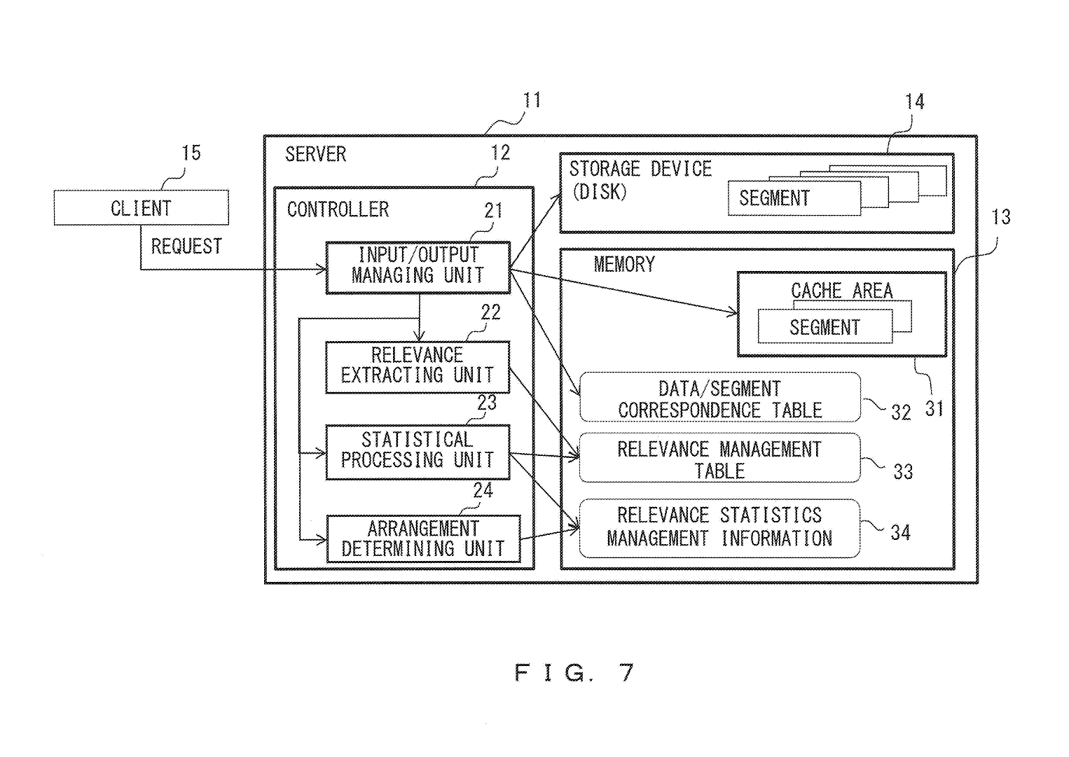

FIG. 7 illustrates an example of a server according to the embodiments. As described above, the server 11 includes the controller 12, the memory 13, and the disk 14. The memory 13 includes an area (hereinafter referred to as a “cache area”) 31 in which a plurality of segments read from the disk 14 are cached, and are temporarily stored. When the capacity of the cache area 31 is insufficient, one of the segments is extracted from the cache area 31 by using an algorithm such as the Least Recently Used (LRU) scheme or the Least Frequently Used (LFU) scheme, and the segment is written back to the disk 14.

The memory 13 stores a data/segment correspondence table 32, a relevance management table 33, and relevance statistics management information 34.

The data/segment correspondence table 32 stores information indicating a correspondence relationship between data and a segment that is an arrangement destination of the data.

The relevance management table 33 stores the number of accesses to a data pair (a relevance ratio), namely, relevance information, during each of the sub-sub-periods Ts within the sub-period Tm.

The relevance statistics management information 34 includes relevance statistics information and relevance statistics (mean) information. The relevance statistics information stores information obtained by performing statistical processing on relevance information during each Tm. The relevance statistics (mean) information is information in which plural pieces of relevance statistics information relating to a mean value during the accumulation period T are collected.

The controller 12 functions as an input/output managing unit 21, a relevance extracting unit 22, a statistical processing unit 23, and an arrangement determining unit 24 by executing a program according to the embodiments.

The input/output managing unit 21 searches the memory 13 in response to a request input from a request source such as the client 15. When data specified in the request does not exist in the memory 13, the input/output managing unit 21 further searches the disk 14, and transmits the data specified in the request to the request source. The request is not always transmitted by the client 15, and another subject of a process performed in the server 11 may be a request issuer. When an input/output device is connected to the server 11, it is assumed that a user inputs a request to the input/output device.

When a request is input, the input/output managing unit 21 searches the memory 13 for data specified in the request. When the data specified in the request exists on the memory 13, the input/output managing unit 21 reads the data from the memory 13, and transmits the data to the request source.

When the data specified in the request does not exist on the memory 13, the input/output managing unit 21 searches the disk 14 for the data specified in the request. When the data specified in the request exists on the disk 14, the input/output managing unit 21 reads all pieces of data included in a segment to which the data specified in the request belongs from the disk 14, by using the data/segment correspondence table 32. The input/output managing unit 21 transmits, to the request source, the data specified in the request from among all pieces of data included in the read segment. In this case, the input/output managing unit 21 stores all pieces of data included in the read segment in the memory 13.

A case in which a process of storing all pieces of data included in the segment read from the disk 14 in the memory 13 is performed at a timing of the issuance of a request has been described above, but the storing process is not limited to this. As an example, the input/output managing unit 21 may obtain an access frequency during a prescribed period, read a segment having a high access frequency from the disk 14 with priority, and store the segment in the memory 13.

The relevance extracting unit 22 monitors a relevance ratio between pieces of data based on a frequency of access to a data pair during each of the sub-sub-periods Ts. More specifically, the relevance extracting unit 22 extracts a data pair consecutively accessed during each of the sub-sub-periods Ts from an access sequence, and increments a frequency of access to the data pair (the relative ratio) by 1.

The statistical processing unit 23 performs statistical processing on the relevance ratio of the pair monitored during each of the sub-sub-periods Ts, and determines whether the pair is a pair having a relevance ratio representing a specified tendency on the basis of a tendency of the relevance ratio obtained as a result of the statistical processing. More specifically, the statistical processing unit 23 calculates a statistic of relevance information for each of the sub-periods Tm by using the relevance management table 33, and invalidates invalid relevance information.

The arrangement determining unit 24 groups pieces of data according to the determination result and the relevance ratio, and specifies pieces of data to be arranged in each of the groups (segments). More specifically, the arrangement determining unit 24 specifies pieces of data to be arranged in each of the segments for each of the accumulation periods T on the basis of relevance information between pieces of data as opposed to the invalidated relevance information. Then, the arrangement determining unit 24 clears the content of the relevance management table 33 and the content of the relevance statistics management information 34.

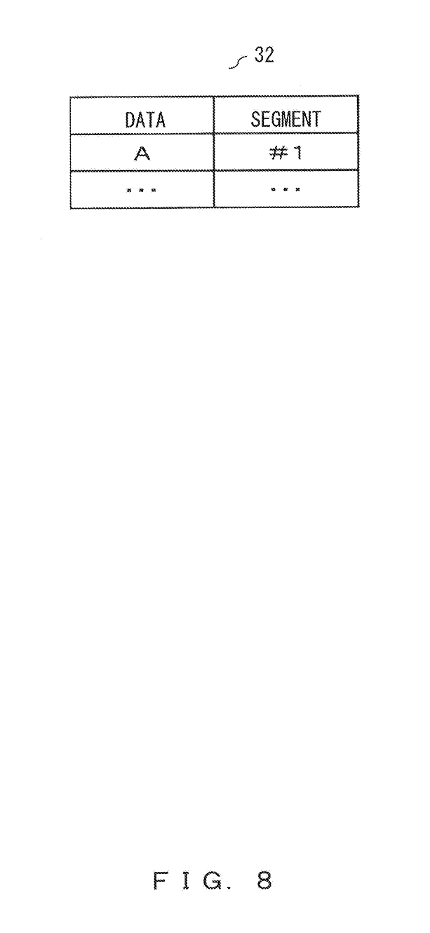

FIG. 8 illustrates an example of a data/segment correspondence table according to the embodiments. The data/segment correspondence table 32 stores the data names (or keys) of all pieces of data stored in the memory 13 and the disk 14, and segment names that respectively correspond to the data names, in association with each other.

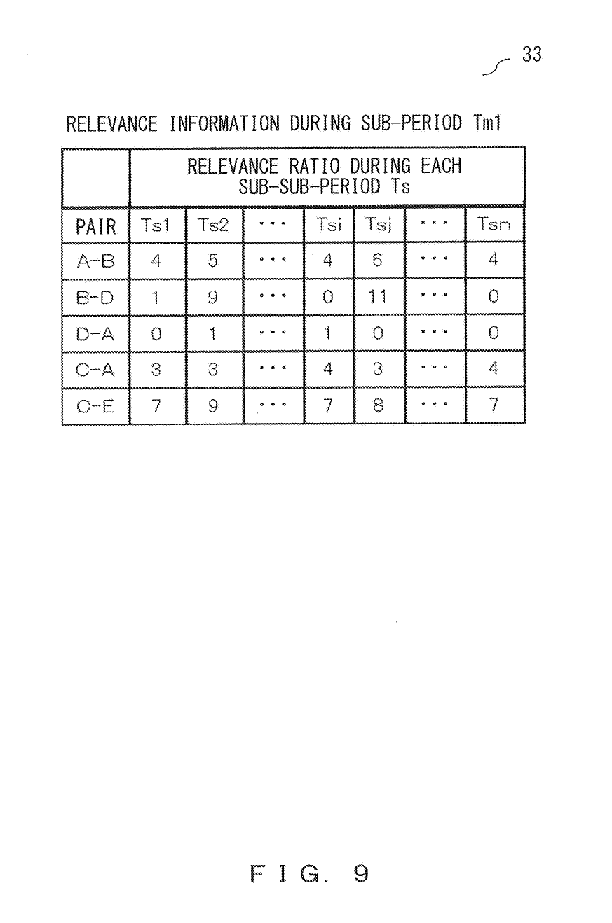

FIG. 9 illustrates an example of a relevance management table according to the embodiments. The relevance management table 33 sequentially associates data specified in a previous request with data specified in a current request so as to generate a data pair, and stores the number of accesses to each of the data pairs (the intensity of relevance), namely, relevance information, during each of the sub-sub-periods within the sub-period Tm.

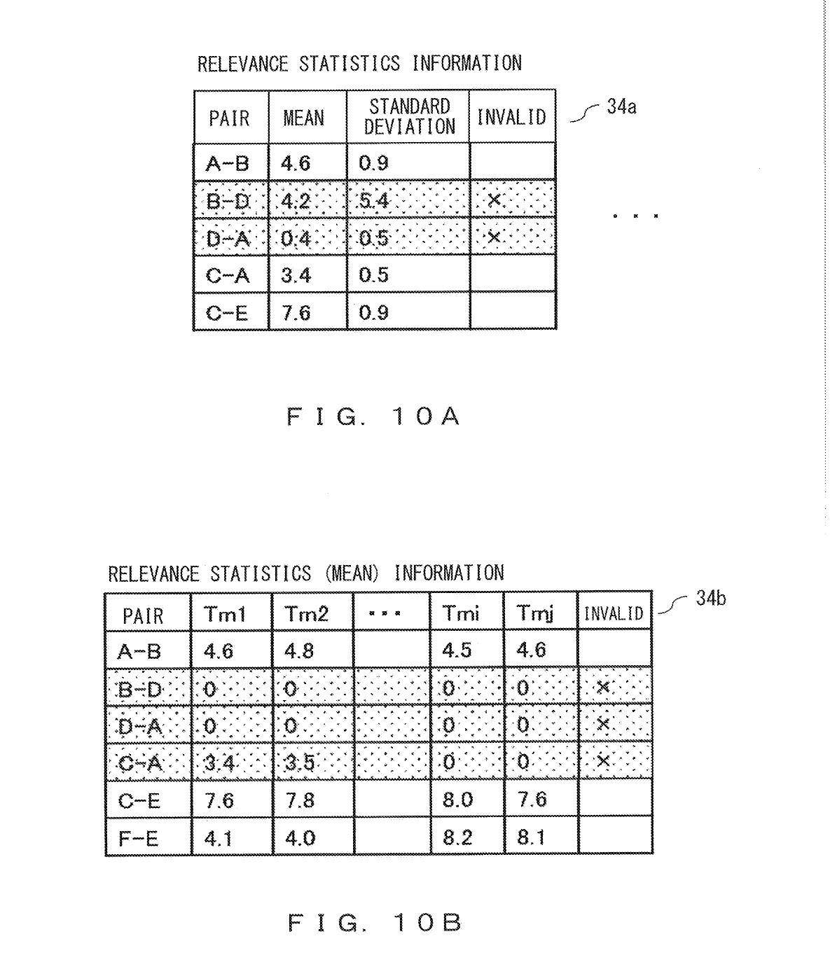

FIGS. 10A and 10B illustrate an example of relevance statistics management information according to the embodiments. The relevance statistics management information 34 includes a relevance statistics information table 34a and a relevance statistics (mean) information table 34b.

The relevance statistics information table 34a stores information (a mean value and a standard deviation) obtained by performing statistical processing on relevance information of a data pair during each Tm, by using the relevance management table 33. In the relevance statistics information table 34a, an invalid flag is added to the relevance information of the data pair when a result of the statistical processing satisfies a prescribed condition (for example, mean value ≦1, or standard deviation ≧1).

The relevance statistics (mean) information table 34b represents information in which a plurality of mean values during the accumulation period T are collected from the relevance statistics information table 34a. When the relevance statistics information table 34a is summarized, a mean value of a data pair to which the invalid flag has been added is set to “0”. In the relevance statistics (mean) information table 34b, a data pair to which the invalid flag has been added in the middle of the accumulation period T, such as a data pair C-A, is also added to the invalid flag.

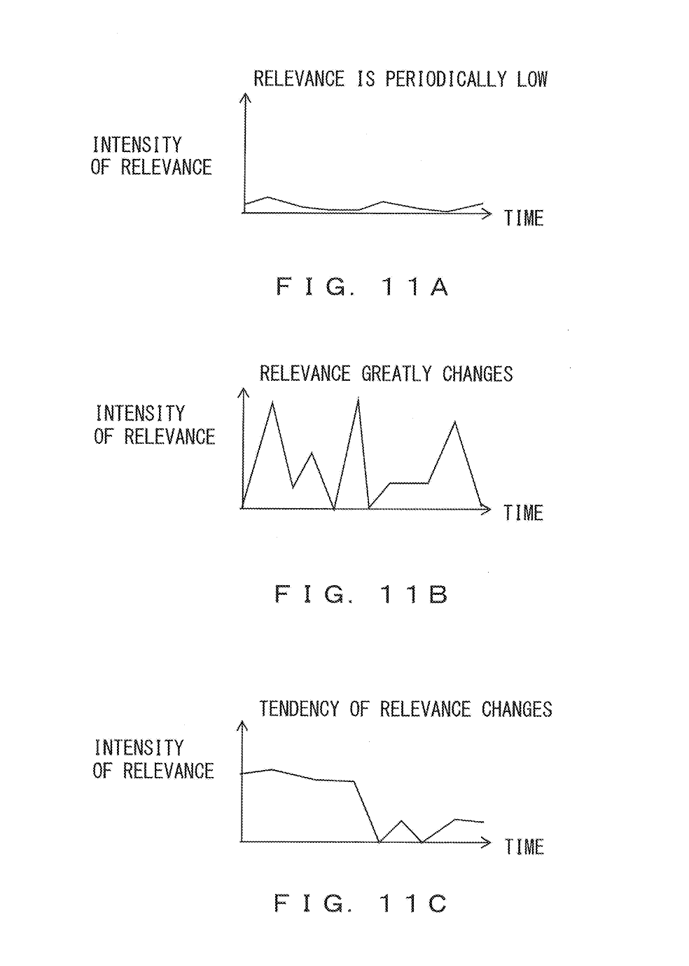

FIGS. 11A to 11C illustrate examples of invalid relevance information according to the embodiments. In the graphs of FIGS. 11A to 11C, a horizontal axis represents time, and a vertical axis represents the intensity of relevance of a data pair. Examples of the invalid relevance information include a data pair that stationarily has a low relevance (FIG. 11A), a data pair that greatly changes in relevance (FIG. 11B), and a data pair that changes in a tendency of relevance (FIG. 11C).

At the last of the accumulation period T, data arrangement is determined by using valid relevance information in the data rearrangement technology.

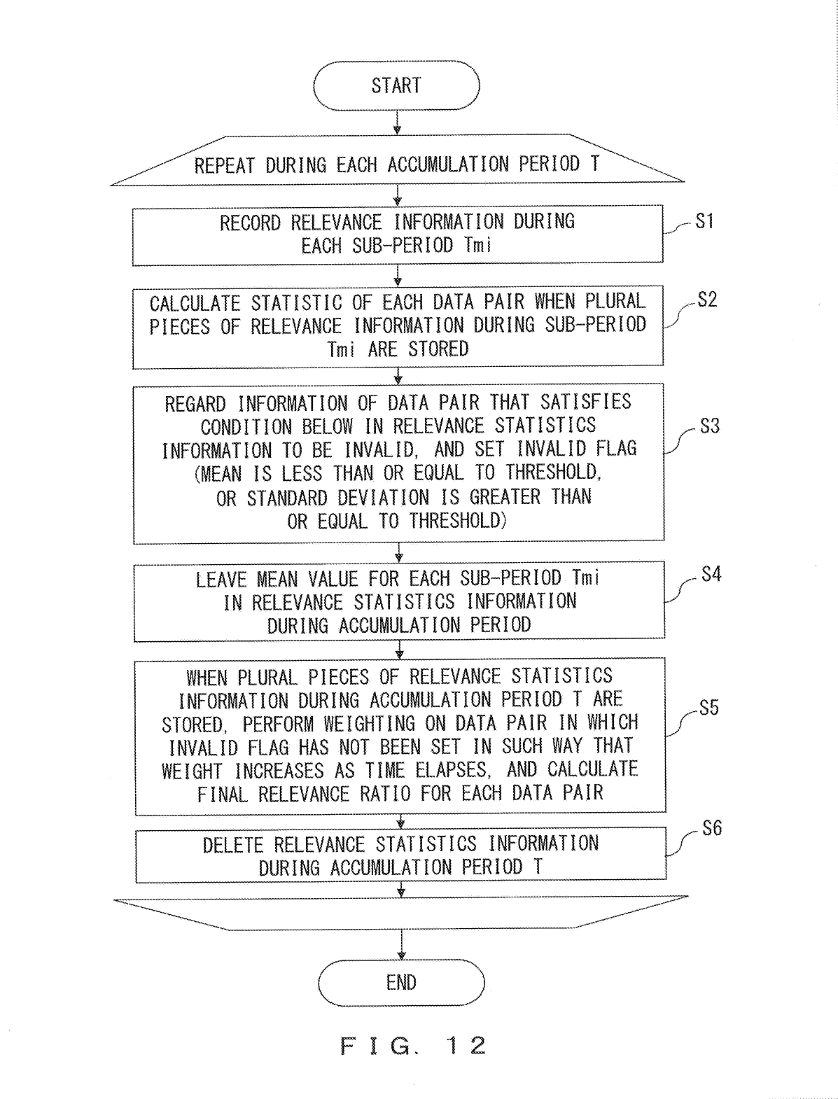

FIG. 12 illustrates a flow of a process of accumulating relevance information according to the embodiments. The flow of FIG. 12 is described below with reference to FIG. 9 and FIGS. 10A and 10B.

First, the relevance extracting unit 22 extracts a consecutively accessed data pair from an access sequence. As described above with reference to FIG. 9, the relevance extracting unit 22 records relevance information of the extracted data pair for each of the sub-sub-periods Ts within a sub-period Tmi in the relevance management table 33 (namely, the relevance extracting unit 22 increments the number of accesses by 1) (S1).

When a plural pieces of relevance information during the sub period Tmi are recorded, the statistical processing unit 23 calculates a statistic (such as a mean value or a standard deviation) of the relevance information (the number of accesses) of each of the data pairs, as illustrated in FIG. 10A, and generates the relevance statistics information table 34a (S2).

The statistical processing unit 23 regards, as invalid information, information of a data pair that satisfies either of a condition whereby the mean value of the number of accesses is less than or equal to a threshold, or a condition whereby the standard deviation is greater than or equal to a threshold, in the relevance statistics information table 34a, as illustrated in FIG. 10A, and sets an invalid flag (S3). As described above, when the invalid flag is set in FIG. 10A, the statistical processing unit 23 sets the mean value of the relevance ratio to 0. By doing this, as described above with reference to FIGS. 11A and 11B, relevance information of a data pair that stationarily has a low relevance ratio (condition: the mean value of the number of accesses is less than or equal to a threshold), or relevance information of a data pair that greatly changes in relevance (condition: the standard deviation is greater than or equal to a threshold) can be eliminated.

The statistical processing unit 23 only leaves the mean value for each of the sub-periods Tmi in the relevance statistics information table 34a during the accumulation period so as to generate the relevance statistics (mean) information table 34b, as illustrated in FIG. 10B (S4). In the relevance statistics (mean) information table 34b, the statistical processing unit 23 also adds an invalid flag to each of the data pairs to which the invalid flag has been added in the middle of the accumulation period T. As a result, as described above with reference to FIG. 11C, relevance information of a data pair that changes in the tendency of the relevance ratio in the middle so as to decrease in the relevance ratio is eliminated.

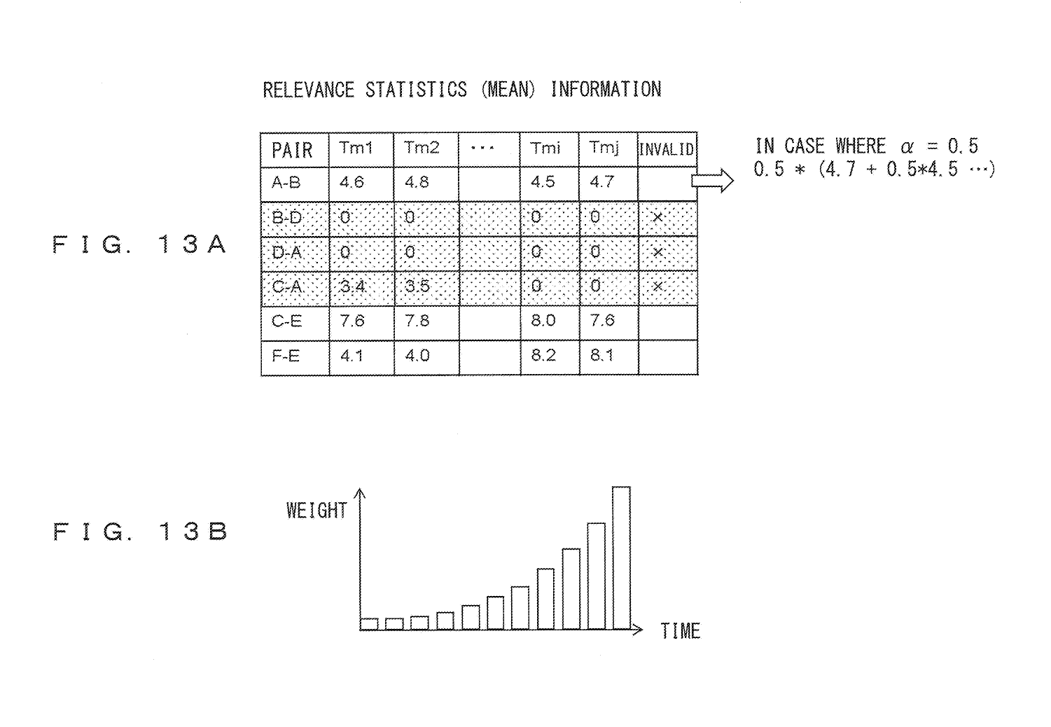

When a plural pieces of information in the relevance statistics information table 34a for the accumulation period T are stored, namely, when the relevance statistics (mean) information table 34b is generated, the arrangement determining unit 24 performs a process that follows. Specifically, the arrangement determining unit 24 performs weighting on the mean value of the relevance ratio for each of the sub-periods of a data pair in which the invalid flag has not been set in such a way that a weight increases as a time period elapses, and calculates a final relevance ratio for each of the data pairs (S5). The process of S5 is described below with reference to FIGS. 13A and 13B.

The arrangement determining unit 24 deletes the relevance statistics management information 34 after calculating the final relevance ratio (S6).

The controller 12 repeats the processes of S1 to S6 during each of the accumulation periods. In the relevance statistics information table 34a and the relevance statistics (mean) information table 34b, rows in which the invalid flag has been set may be appropriately deleted, or may be ignored when calculating optimum arrangement.

FIGS. 13A and 13B are diagrams explaining a process (S5) of calculating final relevance information according to the embodiments.

The arrangement determining unit 24 extracts data pairs in which the invalid flag has not been set from the relevance statistics (mean) information table 34b, and calculates a final relevance ratio for each of the data pairs by using the expression described below. A weight on a sub-period k (k=1 to N, and N: the number of sub-periods) is determined as described below. When an Exponentially Weighted Moving Average is used, the arrangement determining unit 24 exponentially reduces a weight in an order from an immediately previous sub-period to a past sub-period.

Assume that a relevance ratio of a data pair X-Y during the sub-period k is Pₖ. The arrangement determining unit 24 obtains a final relevance ratio REL of the data pair X-Y during the accumulation period T by using the following expression.

REL_{X-Y}=α×(P_{N}+(1−α)P_{N-1}+(1−α²)P_{N-2}+ . . . )

where α represents a smoothing coefficient (0 to 1) for obtaining a degree of a decrease in a weight, and is specified in advance.

As illustrated in FIG. 13A, for example, when α=0.5 is established, the final relevance ratio REL of a data A-B is obtained by calculating REL_{A-B}=0.5*(4.7+0.5*4.5+ . . . ).

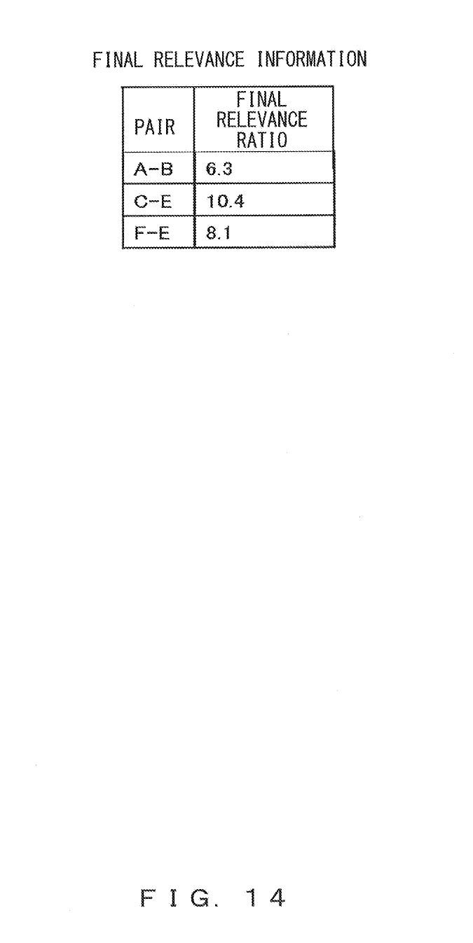

FIG. 14 illustrates finally obtained relevance information for each data pair according to the embodiments. As a result of the process of S5 in FIG. 12, the final relevance information illustrated in FIG. 14 is obtained.

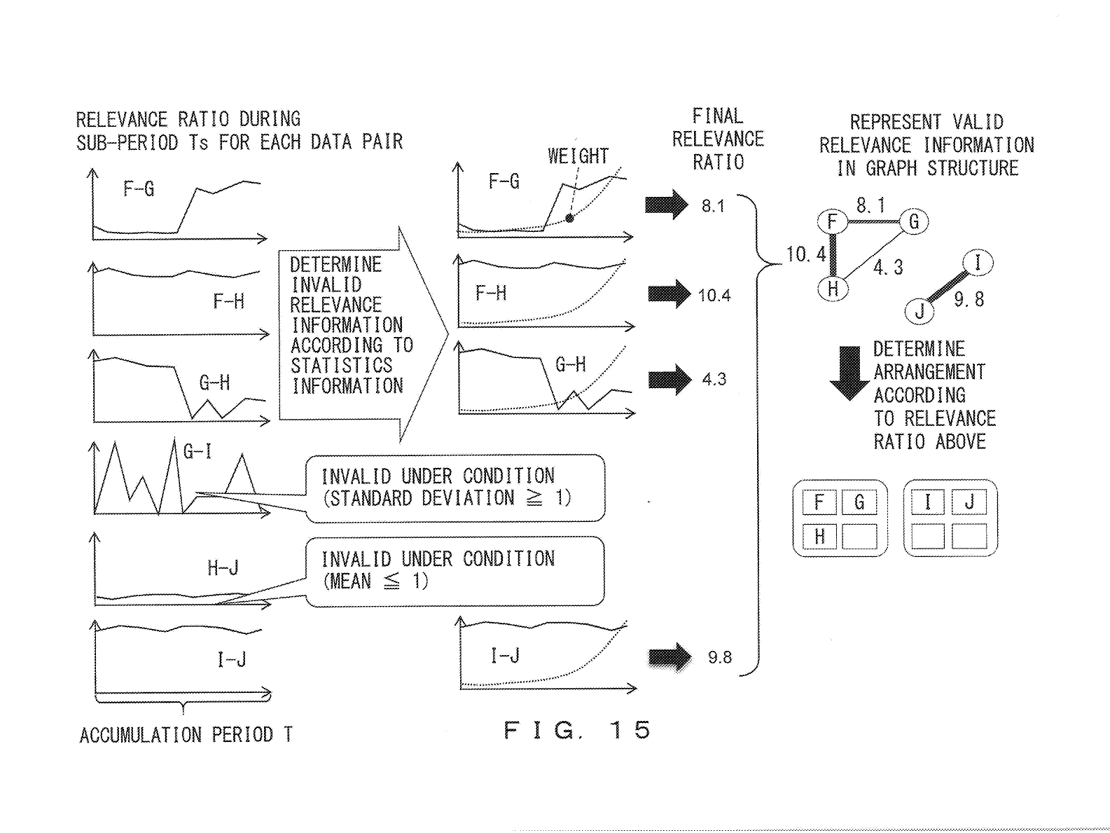

FIG. 15 is a diagram explaining relevance information and the determination of data arrangement according to the embodiments. In FIG. 15, pieces of data F, G, H, I, and J are used, and data pairs F-G, F-H, G-H, G-I, H-J, and I-J are used, for convenience of explanation.

A left-hand portion of FIG. 15 illustrates relevance information obtained by measuring the number of accesses for each of the data pairs in units of the sub-sub period Ts, as in the description above of the process of S1 in FIG. 12. From among the obtained pieces of relevance information for the respective data pairs, invalid relevance information is determined by using statistics information, as in the description above of the processes of S2 to S4 in FIG. 12.

The relevance information of the data pair G-I drastically changes, and therefore the relevance information is assumed to satisfy the condition (standard deviation ≧1). In this case, the statistical processing unit 23 determines that the relevance information of the data pair G-I is invalid.

The relevance information of the data pair H-J stationarily has a low relevance ratio, and therefore the relevance information is assumed to satisfy the condition (mean value ≧1). In this case, the statistical processing unit 23 determines that the relevance information of the data pair H-J is invalid. Accordingly, relevance information of the data pairs F-G, F-H, G-H, and I-J, which has not been determined to be invalid, is valid.

As in the description above of the process of S5 in FIG. 12, the arrangement determining unit 24 performs weighting on the relevance information of the data pairs F-G, F-H, G-H, and I-J, which has not been determined to be invalid, in such a way that a weight increases as a time period elapses, and calculates a final relevance ratio for each of the data pairs. In the example of FIG. 15, the final relevance ratio of the data pair F-G is 8.1. The final relevance ratio of the data pair F-H is 10.4. The final relevance ratio of the data pair G-H is 4.3. The final relevance ratio of the data pair I-J is 9.8.

A graph structure of valid relevance information is represented as illustrated in an upper-right portion of FIG. 15. The arrangement determining unit 24 determines data arrangement for each segment on the basis of the relevance ratio in this graph structure (a lower-right portion of FIG. 15). In this case, it is assumed that a small number of accesses extend between two segments. Consequently, the number of accesses to a disk decreases.

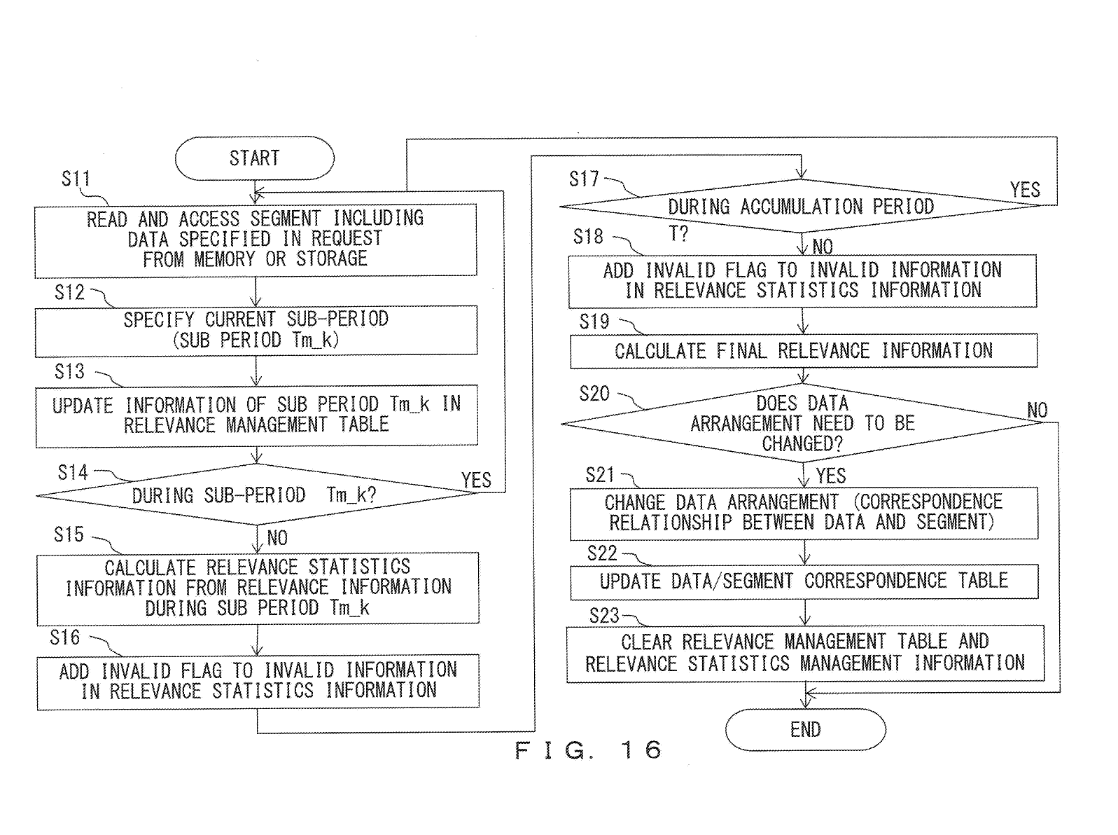

FIG. 16 illustrates an example of a flow from the arrival of a request to the determination of arrangement according to the embodiments. The controller 12 functions as the input/output managing unit 21, the relevance extracting unit 22, the statistical processing unit 23, and the arrangement determining unit 24 by executing a program according to the embodiments.

The input/output managing unit 21 reads (accesses) data specified in a request input from a request source from the memory 13 or the disk 14, and transmits the data to the request source (S11). When the data specified in the request does not exist in the memory 13, the input/output managing unit 21 reads all pieces of data included in a segment to which the data specified in the request belongs from the disk 14, by using the data/segment correspondence table 32. The input/output managing unit 21 then transmits, to the request source, the data specified in the request from among all read pieces of data included in the segment.

The relevance extracting unit 22 specifies a current sub-period Tm_k from among sub-periods within the accumulation period T (S12).

The relevance extracting unit 22 updates information of the sub-period Tm_k in the relevance management table (S13). Specifically, the relevance extracting unit 22 records relevance information of the extracted data pair for each of the sub-sub-periods Ts within the sub-period Tm_k, in the relevance management table 33 (namely, the relevance extracting unit 22 increments the number of accesses by 1), as in the description above of the process of S1 in FIG. 12.

During the sub-period Tm, the relevance extracting unit 22 repeats the processes of S11 to S13 (“YES” in S14).

When the sub-period Tm has passed (“NO” in S14), the statistical processing unit 23 calculates relevance statistics information on the basis of the relevance information during the sub-period Tm_k (S15). Specifically, as in the description above of the process of S2 in FIG. 12, when a plural pieces of relevance information (the number of accesses) during the sub-period Tm_k are accumulated, the statistical processing unit 23 calculates a statistic (a mean value and a standard deviation) of relevance information of each of the data pairs, as illustrated in FIG. 10A, and generates the relevance statistics information table 34a.

The statistical processing unit 23 adds an invalid flag to invalid information in the generated relevance statistics information (S16). Specifically, the statistical processing unit 23 regards information of a data pair that satisfies either of a condition whereby the mean value of the number of accesses is less than or equal to a threshold and a condition whereby the standard deviation is greater than or equal to a threshold in the relevance statistics information table 34a (FIG. 10A) to be invalid, and sets an invalid flag. As described above, when the invalid flag is set in FIG. 10A, the statistical processing unit 23 sets the mean value of the relevance ratio to 0.

When the accumulation period T has not yet passed (“YES” in S17), the process returns to S11, and the processes of S11 to S16 are performed during the subsequent sub-period Tm_k+1.

When the accumulation period T has passed (“NO” in S17), the statistical processing unit 23 adds an invalid flag to invalid information in the relevance statistics information (S18). Specifically, as in the description above of the process of S4 in FIG. 12, the statistical processing unit 23 only leaves the mean value for each of the sub-periods Tmi in the relevance statistics information table 34a during the accumulation period so as to generate the relevance statistics (mean) information table 34b (FIG. 10B). The statistical processing unit 23 also adds the invalid flag to a data pair to which the invalid flag has been added in the middle of the accumulation period T, in the relevance statistics (mean) information table 34b.

The arrangement determining unit 24 calculates final relevance information (S19). Specifically, as in the descriptions above of the process of S5 in FIG. 12, and FIGS. 13A and 13B, the arrangement determining unit 24 performs weighting on the data pair in which the invalid flag has not been set in the relevance statistics (mean) information table 34b in such a way that a weight increases as time elapses, and calculates a final relevance ratio for each of the data pairs.

Then, the arrangement determining unit 24 determines whether data arrangement needs to be changed, on the basis of the calculated final relevance ratio for each of the data pairs (S20). In this case, the arrangement determining unit 24 determines whether the correspondence of data and a segment needs to be changed, namely, whether segments needs to be reorganized, on the basis of the calculated final relevance ratio for each of the data pairs. As described with reference to FIG. 15, the arrangement determining unit 24 represents valid relevance information in a graph structure by using the final relevance ratio for each of the data pairs, and groups data according to the graph structure. When the configuration of data included in a group (segment) is changed as a result of grouping, the arrangement determining unit 24 determines that data arrangement needs to be changed.

When data arrangement does not need to be changed, namely, when it is determined that the correspondence of data and a segment does not need to be changed (“NO” in S20), the arrangement determining unit 24 terminates the process in this flowchart.

When data arrangement needs to be changed, namely, when it is determined that the correspondence of data and a segment needs to be changed (“YES” in S20), the arrangement determining unit 24 performs a process that follows. Specifically, the arrangement determining unit 24 changes the correspondence of data and a segment on the basis of a result of reconfiguration of segments performed in S20 (S21).

The arrangement determining unit 24 updates the data/segment correspondence table 32 on the basis of the changed correspondence relationship between data and a segment (S22).

Then, the arrangement determining unit 24 deletes the relevance management table 33 and the relevance statistics management information 34 (S23).

According to the embodiments, valid relevance information and invalid relevance information for rearrangement are distinguished from each other. As a result, when the invalid relevance information is appropriately deleted, an amount of data stored for optimization can be reduced. When the invalid relevance information is not used in the calculation of arrangement, targets for the calculation process can be reduced. Further, when the invalid relevance information is not used in the calculation of arrangement, arrangement that appears to be valid (namely, arrangement that temporarily has a high relevance ratio), but actually has a low effect (namely, arrangement whereby an effect is lost immediately after rearrangement) can be prevented.

According to an aspect of the invention, data arrangement can be attained that has a high efficiency in reading in accordance with a change in a tendency of a data access situation.

The invention is not limited to the embodiments described above, and various configurations and embodiments can be embodied without departing form the spirit of the invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process for managing data, the process comprising:
monitoring a relevance ratio between pieces of data based on a frequency of access to a pair for each of the pairs of the pieces of data consecutively accessed in response to a request for access to a storage device storing a plural pieces of data;
determining whether the pair is a pair having a relevance ratio representing a specified tendency, on the basis of tendencies of the monitored relevance ratios of the pairs; and
grouping the plural pieces of data according to a result of the determining and the relevance ratio, and specifying data to be arranged in each group.

2. The non-transitory computer-readable recording medium according to claim 1, wherein
the monitoring the relevance ratio divides a period during which the tendency of the relevance ratio is observed into a plurality of periods, and monitors the relevance ratio between the pieces of data based on the frequency of the access to the pair during each of the divided plurality of periods.

3. The non-transitory computer-readable recording medium according to claim 2, wherein
the determining calculates a mean or a standard deviation of the monitored relevance ratios during the divided period for each of the pairs, and specifies a pair having the relevance ratio in which the calculated mean or standard deviation satisfies a specified condition.

4. The non-transitory computer-readable recording medium according to claim 3, wherein
the specifying data to be arranged calculates, for each of the pairs, the relevance ratio during the period during which the tendency of the relevance ratio is observed, by performing weighting on the mean of the relevance ratio during each of the divided periods of the pair as opposed to the pair having the relevance ratio representing the specified tendency in such a way that a weight decreases in an order from the divided period just before to the divided period in the past.

5. The non-transitory computer-readable recording medium according to claim 1, wherein
the specifying data to be arranged groups the pairs as opposed to the pair having the relevance ratio representing the specified tendency.

6. A data management device comprising:
a processor that executes a process including:
monitoring a relevance ratio between pieces of data based on a frequency of access to a pair for each of the pairs of the pieces of data consecutively accessed in response to a request for access to a storage device storing a plural pieces of data;
determining whether the pair is a pair having a relevance ratio representing a specified tendency, on the basis of tendencies of the monitored relevance ratios of the pairs; and
grouping the plural pieces of data according to a result of the determining and the relevance ratio, and specifying data to be arranged in each group.

7. The data management device according to claim 6, wherein
the monitoring the relevance ratio divides a period during which the tendency of the relevance ratio is observed into a plurality of periods, and monitors the relevance ratio between the pieces of data based on the frequency of the access to the pair during each of the divided plurality of periods.

8. The data management device according to claim 7, wherein
the determining calculates a mean or a standard deviation of the monitored relevance ratios during the divided period for each of the pairs, and specifies a pair having the relevance ratio in which the calculated mean or standard deviation satisfies a specified condition.

9. The data management device according to claim 8, wherein
the specifying data to be arranged calculates, for each of the pairs, the relevance ratio during the period during which the tendency of the relevance ratio is observed, by performing weighting on the mean of the relevance ratio during each of the divided periods of the pair as opposed to the pair having the relevance ratio representing the specified tendency in such a way that a weight decreases in an order from the divided period just before to the divided period in the past.

10. The data management device according to claim 6, wherein
the specifying data to be arranged groups the pairs as opposed to the pair having the relevance ratio representing the specified tendency.

11. A data management method performed by a computer, the data management method comprising:
monitoring, by the computer, a relevance ratio between pieces of data based on a frequency of access to a pair for each of the pairs of the pieces of data consecutively accessed in response to a request for access to a storage device storing a plural pieces of data;
determining, by the computer, whether the pair is a pair having a relevance ratio representing a specified tendency, on the basis of tendencies of the monitored relevance ratios of the pairs; and
grouping, by the computer, the plural pieces of data according to a result of the determining and the relevance ratio, and specifying data to be arranged in each group.

12. The data management method according to claim 11, wherein
the monitoring the relevance ratio divides a period during which the tendency of the relevance ratio is observed into a plurality of periods, and monitors the relevance ratio between the pieces of data based on the frequency of the access to the pair during each of the divided plurality of periods.

13. The data management method according to claim 12, wherein
the determining calculates a mean or a standard deviation of the monitored relevance ratios during the divided period for each of the pairs, and specifies a pair having the relevance ratio in which the calculated mean or standard deviation satisfies a specified condition.

14. The data management method according to claim 13, wherein
the specifying data to be arranged calculates, for each of the pairs, the relevance ratio during the period during which the tendency of the relevance ratio is observed, by performing weighting on the mean of the relevance ratio during each of the divided periods of the pair as opposed to the pair having the relevance ratio representing the specified tendency in such a way that a weight decreases in an order from the divided period just before to the divided period in the past.

15. The data management method according to claim 11, wherein
the specifying data to be arranged groups the pairs as opposed to the pair having the relevance ratio representing the specified tendency.
